(19) United States
(12) Patent Application Publication
(10) Pub. No.: US 2006/0175795 A1
(43) Pub. Date: Aug. 10, 2006

(54) Attachable bicycle transmission

(76) Inventor: Ezekiel Eagle Corson, Tahoe City, CA (US)

Correspondence Address: EZEKIEL E. CORSON, PO. BOX 3375, OLYMPIC VALLEY, CA, 96146, US

(21) Appl. No.: 11/347,470

(22) Filed: Feb. 3, 2006

Related U.S. Application Data
(60) Provisional application No. 60/650,926, filed on Feb. 7, 2005.

(51) Int. Cl. B62M 1/02

(52) U.S. Cl. 280/260

(57) ABSTRACT

A multi-speed attachable bicycle transmission that easily mounts to a bicycle frame, specifically, at the bottom bracket housing location, so that the transmission housing and internally rotatably mounted components are positioned in front of the bottom bracket housing of the bicycle frame, but in back of the front wheel. Mounting capability requires no specialty bicycle frame or bicycle frame reconfigurations. The attachable bicycle transmission invention allows the user to simply fasten it to a bicycle of choice and utilize extremely reliable, durable, and accurate gear ratio shifting. The attachable multi-speed bicycle transmission can be used in conjunction with many types of drivetrain types including, but not limited to; chain, shaft, and belt drive systems.

### BACKGROUND OF THE INVENTION

1. Field of the Invention

This invention relates to multi-speed bicycles where gear ratios are shifted by means of a transmission or a derailleur system that utilizes paired chain rings for ratio determination and, more particularly, to multi-speed bicycle transmissions that are trying to promote more durable, functional, and efficient designs.

2. Description of Background Art

Historically, multi-speed bicycles have utilized derailleur type shifting components in conjunction with a chain, chain rings, and sprockets to handle all input to output power ratio increases and decreases by selectively moving the chain drive line to different diameter chain ring pairs, creating different ratios and ultimately changing the resistance of applied input power, therefore transmitting adjusted output power.

The disadvantages of the derailleur type systems are many. To briefly describe a few; when the delicate derailleur components fall out of proper adjustment, the chain falls off the chain rings and sprockets; there is a delicate rear derailleur that is always dangling off the back of the bike completely exposed to the elements; and there are many extremely sensitive, moving parts and components that are all unprotected and completely vulnerable to damage that may, and will occur.

With the inevitable complications associated with the use of derailleurs for shifting, the next evolutionary step was to create a shifting device for bicycles that was to be completely concealed from the elements, functional, and reliable. This led to the invention of the very popular shifter hub, which is usually a transmission assembly cased inside of the rear wheel hub. A shifter hub works well in its own right, but the major draw backs of this type of shifting device is it's location and weight. Being located in the rear wheel hub of the bicycle, together with the device's heavy weight, results in unbalanced weight displacement on the bicycle. To make matters worse, a large majority of modern day bicycles are full suspension designs that do not perform well with the rear end of the bike overloaded with excess weight. Misappropriating weight over the bicycle, together with the current preferences associated with the modern suspension bicycles, the shifter hub has its obvious limitations. Even with the negative aspects of this type of transmission, the shifter hub has remained a desirable component in the bicycle industry for many years.

The inherent problems associated with the shifter hub and all previous shifting devices has recently brought forth the popularity of an entirely new type of bicycle shifting mechanism; the “frame integrated” or “built in”, bicycle transmission. This type of bicycle transmission distributes its weight to the center of the bicycle, resulting in better handling and performance characteristics, than that of the bulky shifter hub. These types of “on board bicycle transmissions” are usually completely sealed from the outside elements, reliable, and extremely functional. However, because they are built into the bicycle frame itself, they all posses one significant flaw; they all must use a custom built specialty bicycle frame. This requires the bicycle frame to be designed and configured completely around the transmission housing. This is a serious drawback because it forces bicycle frame designers to either; redesign their bike frames around these large, obtrusive, transmission housings, so that the transmission itself is built into the bicycle frame, or choose to not use them at all. Most of the bicycle frame manufactures do not want to compromise there engineering or designs by any means, so most of them choose to not use them at all.

### BRIEF SUMMARY OF THE INVENTION

Having to reconfigure or redesign a bicycle frame for the use of a bicycle transmission is an impediment to the success of the known, “bicycle transmissions”, and has inspired the advent of this invention, the attachable bicycle transmission. An attachable transmission that can be mounted to the bottom bracket housing of a bicycle of choice, with no specialty bicycle frame or bicycle frame reconfiguration required. The user simply removes their existing bottom bracket set and crank spindle sub-assembly from their bicycle frame, and replaces it with the attachable bicycle transmission. The attachable bicycle transmission housing slips around the bicycle frame's bottom bracket housing and is fastened in place by installing the bottom bracket crank spindle subassembly through the transmission and the frame's bottom bracket housing, locking it into place. Additional securing to the bicycle frame can also be achieved by utilizing the ISCG (International Standard Chain Guide mount) bolt holes that exist on the bottom bracket housings of certain mountain bike and BMX frames. This invention is a transmission that exists as an attachable bicycle component rather than a built in section of the bicycle frame. This is a novel invention that is currently unavailable.

It would be very desirable to have a multi-speed attachable bicycle transmission, with all shifting components concealed in a housing, protected from the elements and all other potentially destructive forces that may damage the many delicate internal parts of the transmission. Furthermore, to have the ability to mount this attachable transmission to the bottom bracket housing of any bicycle the user chooses, as well as giving the bicycle frame manufacturers freedom to design their frames however they like, with no compromise. A multi-speed bicycle transmission that can be simply attached to a bicycle is not available in any form and is by all respects, completely unique. This truly exceptional invention, the attachable bicycle transmission, is a first of its kind.

### BRIEF DESCRIPTION OF THE DRAWINGS

FIG. 1 is a perspective view from the back right of the attachable bicycle transmission 1, there are crank arms 6 and a chain ring 30 mounted to aid in viewing comprehension.

FIG. 2 is a perspective view from the back left of the attachable bicycle transmission 1, there are crank arms 6 and a chain ring 30 mounted to aid in viewing comprehension.

FIG. 3 is a top view of the attachable bicycle transmission 1, there are crank arms 6 and a chain ring 30 mounted to aid in viewing comprehension.

FIG. 4 is a perspective view from the bottom front left of the internal parts assembly of the attachable bicycle transmission with the external housing removed, the chain ring is intact and the crank arms are removed to aid in viewing clarity.

FIG. 5 is an internal subassembly perspective view of the drive gears 15, engagement dogs 16, and engagement capsule 18 system.

FIG. 6 is an exploded subassembly perspective view of the hollow drive shaft 14 and the engagement dogs 16, the engagement dogs 16 are illustrated as they would appear if removed from the shaft.

FIG. 7 illustrates a perspective view of a drive gear 15 and its profile of the engagement grooves on the interior of the gear.

FIG. 8 is an exploded perspective view of the engagement capsule 18 subassembly in place on the cable 17.

FIG. 9 is a perspective view from the front right of a common bicycle 2 with the attachable bicycle transmission 1 mounted to the bicycle frame 5.

FIG. 10 is a perspective view from the under side back left of a common bicycle 2 with the attachable bicycle transmission 1 mounted to the bottom bracket housing 4 of the bicycle frame 5.

FIG. 11 is a perspective view from the front right of a common bicycle 2 with the attachable bicycle transmission 1 removed to show a typical bottom bracket housing 4 of a bicycle frame 5.

### DETAILED DESCRIPTION OF THE PREFERRED EMBODIMENT

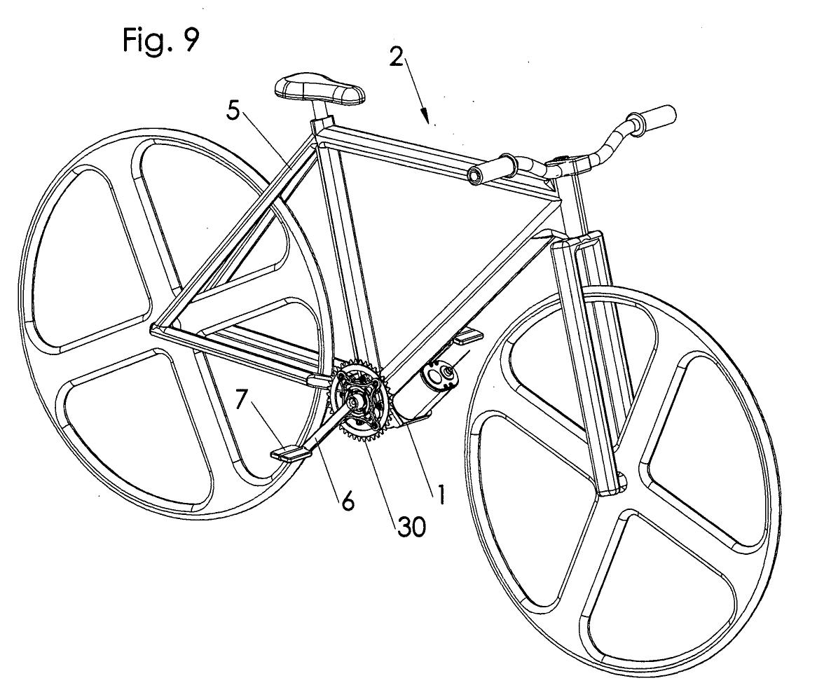

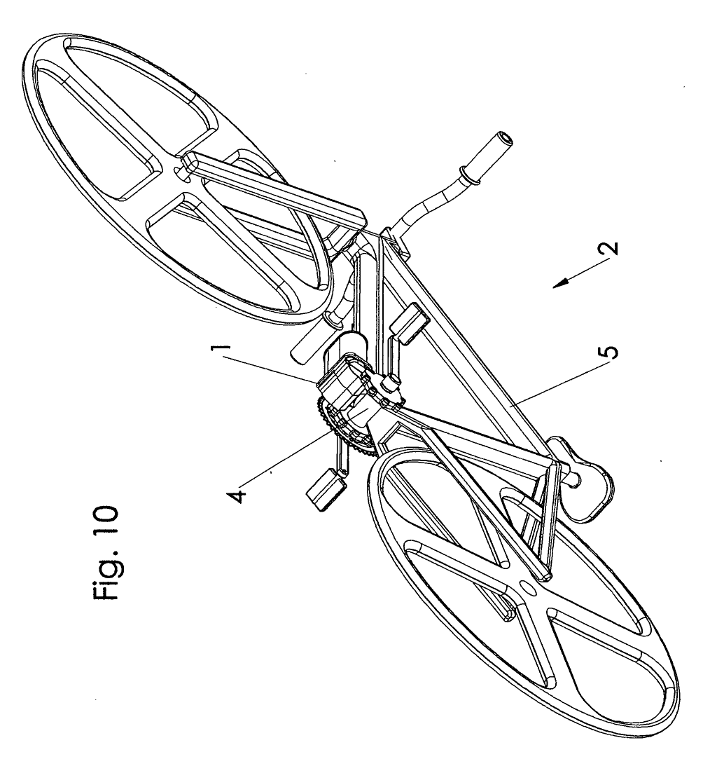

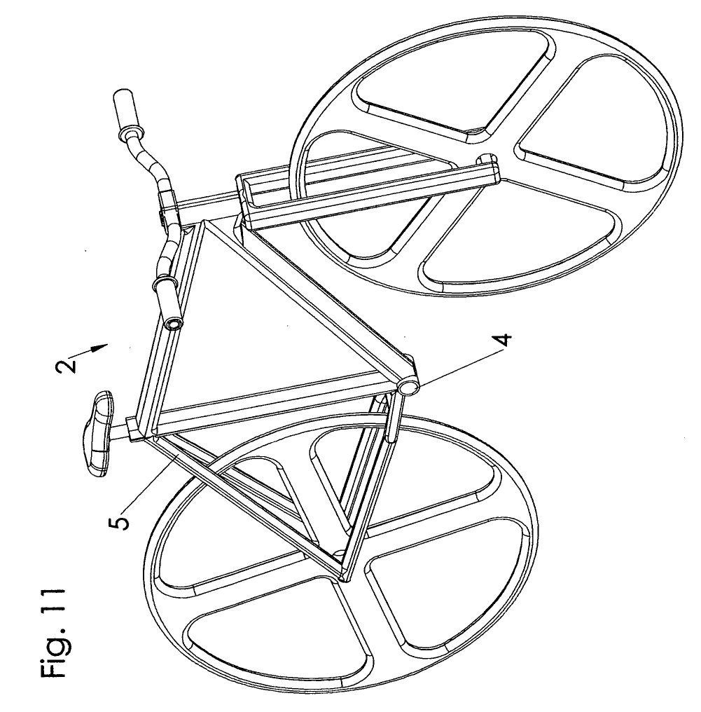

Referring to the drawings of the preferred embodiment for purposes of illustrating this invention only, not for purposes of limiting this invention, FIG. 9 displays the attachable bicycle transmission 1 in its mounted location on a common bicycle 2. The crank spindle shaft 3 is installed through the attachable bicycle transmission 1 and the bottom bracket housing 4 of the bicycle frame 5, therefore locking the transmission to the bicycle frame 5. There are crank arms 6 and pedals 7 shown for image comprehension only, and the chain is removed for image clarity.

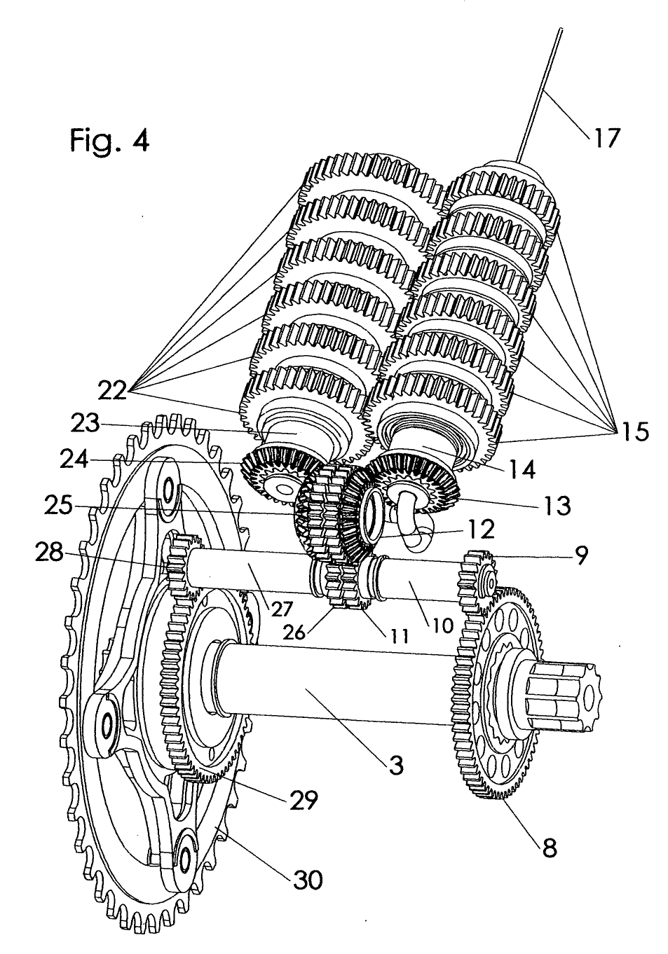

FIG. 4 is an internal perspective view of the attachable bicycle transmission 1 that, according to the present invention, is comprised of: a crank spindle shaft 3 for input power, fixed on the left side of the bottom bracket spindle 3, is the main input force gear 8 acting as the source for all rotational input power for the transmission. This main input force gear 8 drives the left exterior half shaft gear 9 therefore rotating the entire left half shaft 10. From the exterior side of the left half shaft 10 the rotational force is transferred to the left interior half shaft gear 11 which then rotates the left side spur-bevel gear 12 transferring the rotational power ninety degrees into the hollow drive shaft bevel gear 13, therefore rotating the hollow drive shaft 14.

As shown in FIG. 4, the left and right side spur-bevel gears 12, 25 are rotatably mounted on the same axle, but are not coupled together and rotate independently. The left and right half shafts 10, 27 together with their coupled half shaft gears 9, 11, 26, 28, are also rotatably mounted on the same axis, but rotate independently as left and right side subassemblies.

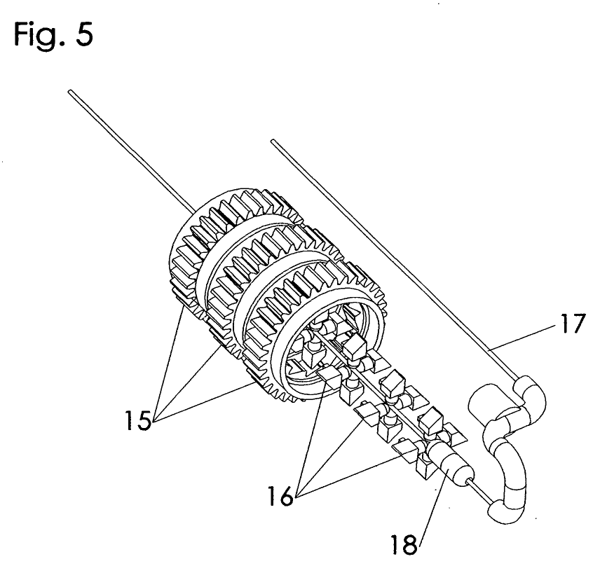

Once the rotational force is sent to the hollow drive shaft 14, FIG. 5 provides an internal illustration of how one of the drive gears 15 can be selected by pushing out the chosen corresponding set of engagement dogs 16 from the interior of the hollow drive shaft 14, and therefore locking the selected drive gear 15 to the hollow drive shaft 14. All of the drive gears 15 rotate independently around the hollow drive shaft 14, until engaged by the selected set of outward pushing engagement dogs 16, from the interior of the hollow drive shaft 14. The hollow drive shaft 14 has been removed from FIG. 5, so that the adjacent internal parts can be clearly displayed. As shown in FIG. 5, the engagement dogs 16, located in the hollow drive shaft 14, are pushed outward by the use of a cable 17 guided engagement capsule 18 that slides through the center of the hollow drive shaft 14, pressing out on each set of chosen engagement dogs 16 as it passes through the hollow drive shaft 14. The engagement dogs 16 selection is made by tensioning the cable 17 according to what the desired drive gear 15 shall be.

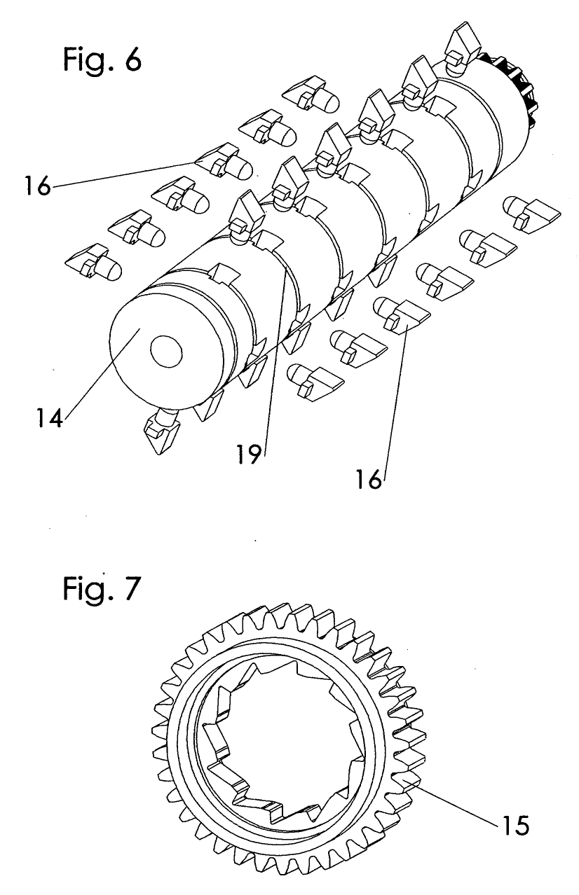

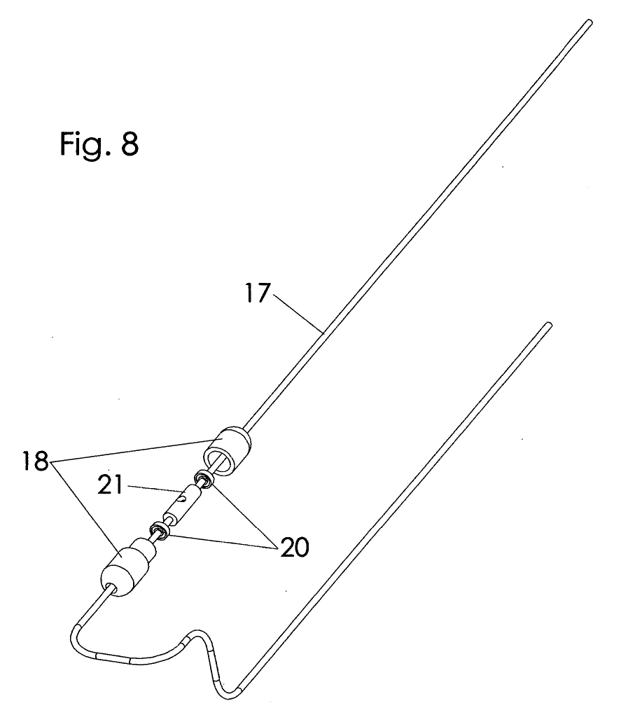

FIG. 6 shows each set of engagement dogs 16 as they would appear if removed from the hollow drive shaft 14. When the gear selection process takes place, the engagement dogs 16 are pushed outward from the hollow drive shaft 14 by the engagement capsule 18, so that they reveal only their tips, therefore locking into the matching engagement grooves of the drive gear 15 and engaging the chosen drive gear 15 to the hollow drive shaft 14. When the engagement capsule 18 slides on to the next set of engagement dogs 16, the previously engaged set of engagement dogs 16 are then retracted back into the hollow drive shaft 14 by a spring like c-clip 19, that is clamped directly around each set of engagement dogs 16 and the hollow drive shaft 14. The cable 17 itself is spring tensioned for return purposes. As shown in FIG. 8 the engagement capsule 18 is rotatably mounted at a specific location of the cable 17 on a set of capsule bearings 20 with a set screw collar 21 locked to the cable 17 between the set of capsule bearings 20.

Referring now to FIG. 4, when a drive gear 15 is selected on the hollow drive shaft 14 the rotational force is then transferred to its corresponding driven gear 22 that is fixed to the driven shaft 23. When one drive gear 15 is selected, all the other non-chosen drive gears 15 rotate freely around the hollow drive shaft 14. The drive gears 15 are stacked inline on the hollow drive shaft 14 and are in a constant meshing type relationship with the driven gears 22 which are also stacked inline, but locked to the driven shaft 23. The hollow drive shaft 14 and the driven shaft 23 rotate on parallel axis.

When the rotational force is passed onto the driven shaft 23, the coupled driven shaft bevel gear 24 also rotates transferring the rotational force ninety degrees to the right side spur-bevel gear 25, therefore rotating the right interior half shaft gear 26. The right interior half shaft gear 26 rotates the entire right half shaft 27. From the interior side of the right half shaft 27, the rotational force is transferred to the right exterior half shaft gear 28.

The right exterior half shaft gear 28 then rotates the spider hub 29, which is rotatably mounted at a fixed position on the crank spindle shaft 3. The rotational force of the spider hub 29 is unaffected by the rotational force of the crank spindle shaft 3, in regards to its mounting location. The chain ring 30 and chain, belt and pulley, or other chosen type of drive train, is then powered by the rotating spider hub 29. At this point the drive train has been activated and the power is transferred to the rear wheel of the bicycle, driving the bicycle forward.

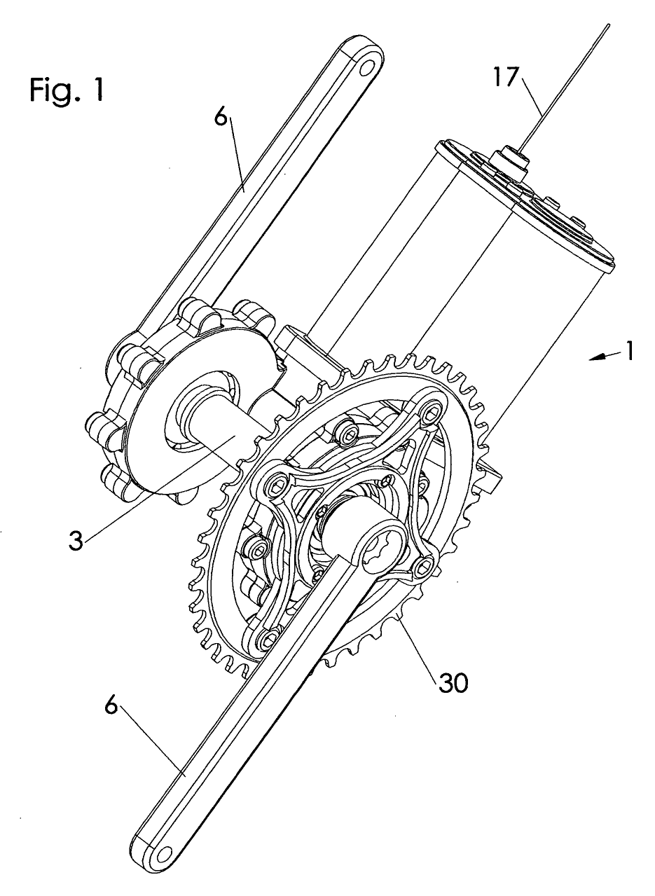

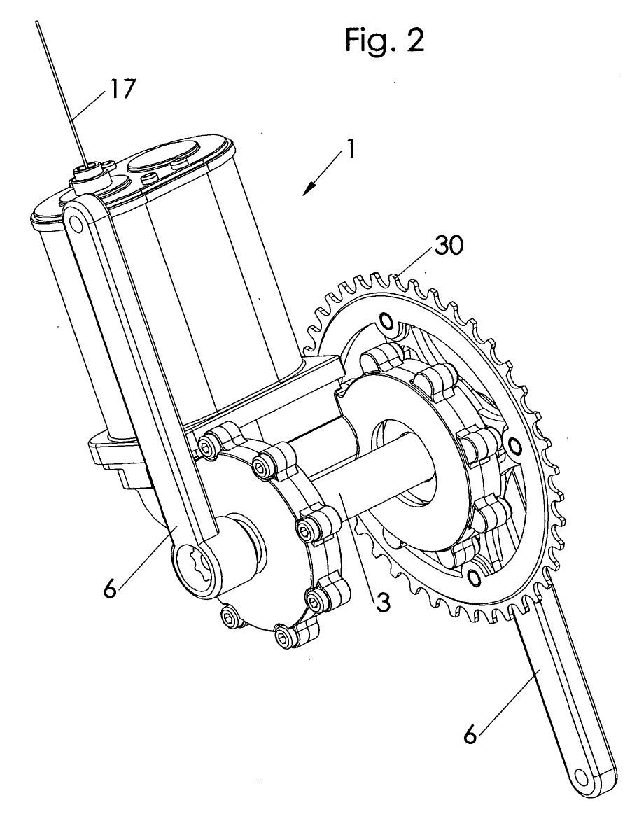

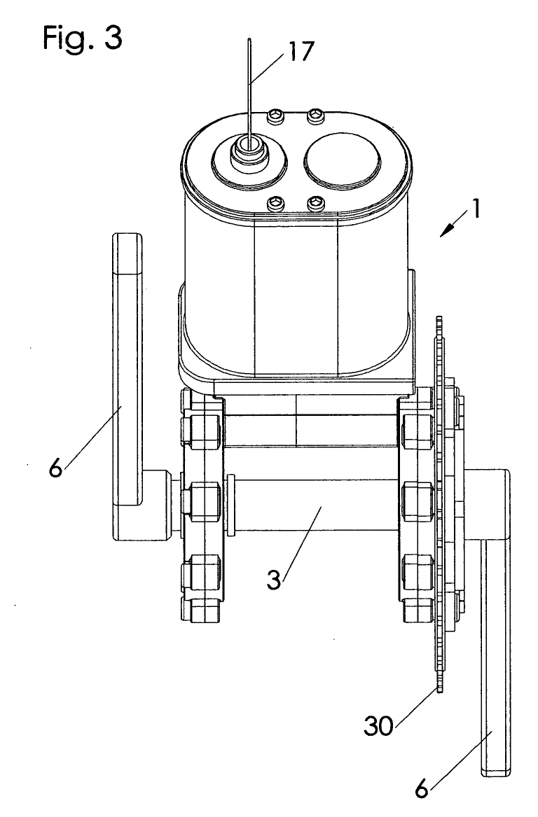

The internal gears and components of the attachable bicycle transmission 1 are rotatably mounted inside of a housing, as shown in FIG. 1, that cleanly fits around the bottom bracket housing of a bicycle frame and is fixed in place, most in part, by the crank spindle shaft 3.

What is claimed is:

1. A multi-speed attachable bicycle transmission mounted on a bottom bracket housing section of a bicycle frame, by installing a crank spindle shaft subassembly through the attachable bicycle transmission housing and bottom bracket housing of a bicycle frame, so that the main transmission housing and internally rotatably mounted components are positioned below and in front of the bottom bracket housing of a bicycle frame, but in back of the front wheel.

2. The multi-speed attachable bicycle transmission of claim 1 wherein mounting capability is achieved with no specialty bicycle frame or bicycle frame reconfiguration required, and is attached to the bottom bracket housing of a bicycle frame as an add component.

3. The multi-speed attachable bicycle transmission of claim 1 wherein the attachable bicycle transmission is locked to the bicycle frame by installing a crank spindle shaft subassembly through the attachable bicycle transmission housing and bottom bracket housing of the bicycle frame.

4. The multi-speed attachable bicycle transmission of claim 3 wherein additional fastening to the bicycle frame also include using the ISCG (International Standard Chain Guide mount) bolt holes that exist on certain mountain bike and BMX frames.

5. The multi-speed attachable bicycle transmission of claim 1 wherein at the exterior left side of the bottom bracket housing location, the crank spindle shaft has a mechanically coupled gear that delivers the rotational force to the input shaft of the transmission.

6. The multi-speed attachable bicycle transmission of claim 5 wherein at the exterior right side of the bottom bracket housing location, the transmission output shaft has a mechanically coupled gear that delivers the rotational force to the chain ring hub or chosen type of drivetrain hub, that is rotatably mounted to the crank spindle shaft at the exterior right side of the bottom bracket housing.

7. The multi-speed attachable bicycle transmission of claim 1 wherein the input and output rotational force is transferred ninety degrees between the crank spindle shaft and the drive/driven gear assembly with the use of bevel gears, to allow the two shafts that carry the drive/driven gear assembly to coexist in a parallel linear fashion, front to back, with the bicycle frame.

8. The multi-speed attachable bicycle transmission of claim 1 wherein a drive gear is engaged with engagement dogs being pushed out from the interior of a hollow drive shaft by a cable guided engagement capsule, so that the engagement dogs lock into the matching engagement grooves on the interior of the drive gear, therefore locking the chosen drive gear to the hollow drive shaft.

9. The multi-speed attachable bicycle transmission of claim 8 wherein the engagement capsule is rotatably mounted at a fixed location of the cable.
